(19) United States
(12) Patent Application Publication
(10) Pub. No.: US 2009/0177901 A1
(43) Pub. Date: Jul. 9, 2009

(54) KVM MANAGEMENT SYSTEM CAPABLE OF CONTROLLING COMPUTER POWER

(75) Inventors: Sun-Chung Chen, Shijr City (TW); Chien-Chung Chen, Shijr City (TW)

Correspondence Address: KIRTON AND MCCONKIE, 60 EAST SOUTH TEMPLE,, SUITE 1800, SALT LAKE CITY, UT, 84111, US

(73) Assignee: ATEN INTERNATIONAL CO., LTD., Taipei (TW)

(21) Appl. No.: 11/971,133

(22) Filed: Jan. 8, 2008

(51) Int. Cl. G06F 1/26

(52) U.S. Cl. 713/310

(57) ABSTRACT

Disclosed is a KVM switch system capable of controlling computer power of a computer coupled therewith. The KVM switch system includes a KVM switch and at least one power control line. The KVM switch generates at least one control signal. The power control line is coupled with a system panel connector of a mainboard of the computer to transmit the control signal of the KVM switch thereto for controlling the computer power. The power control line is coupled with power switch pins or reset switch pins of the system panel connector. The control signal can be generated by a processor of the KVM switch. Alternatively, the control signal can be generated by pushing a power switch button or reset switch button at the KVM switch.

### BACKGROUND OF THE INVENTION

1. Field of the Invention

The present invention generally relates to a KVM switch system and at least one power control line for a computer coupled therewith, and more particularly to a KVM switch system capable of controlling computer power of a computer coupled therewith.

2. Description of Prior Art

A KVM switch system can allow a console user of the KVM to access a plurality of computers coupled therewith as a remote control solution. It is a general job content for the console user to access the computer to execute maintenance, modification, monitor or changing setting on the software operation system of the computer. However, the software operation system sometimes gets into a system crash due to improper operations on the operation system of the computer or problems of the operation system itself. Consequently, it becomes unavoidable to physically shutdown or reboot the computer by the console user himself who must go to a far location where the computer is. Result is inefficient and bothersome.

In the remote control solution industry, there is a management system named IPMI (Intelligent Platform Management Interface) to allow the console user remotely control computer power to deal with the aforementioned system crash. Nevertheless, it is an expensive system and only for special design server with adding a BMC (baseboard management controller) on the mainboard of the server. Additionally, it is restricted in a network-based remote control environment but not for a general KVM switch system.

Moreover, a Guardian management device, such as disclosed in U.S. Pat. No. 6,557,170 which supplies electric power to the plurality of computers and cooperates with the KVM switch also can let the console user selectively control electric power to the computers. However, such solution and the aforementioned IPMI are both expensive and much complicated in hardware or software structure. In a console user's point of view, an easy and simple solution is essential and desired for consideration of practical operation on the KVM management system.

### SUMMARY OF THE INVENTION

Consequently, there is a need to develop a KVM management system capable of controlling computer power which is easy and simple for solving drawbacks of prior arts.

An objective of the present invention is to provide a KVM management system capable of controlling computer power of at least one computer coupled therewith directly and simply for a console user of the KVM management system.

Another objective of the present invention is to provide at least one power control line to transmit the control signal of the KVM switch generated by the console user to control the computer power cheap and easy.

Briefly summarized, the KVM switch generates at least one control signal and sends through at least one power control line. The power control line includes a first end to receive the control signal from the KVM switch and a second end coupled with a system panel connector of a mainboard of the computer to transmit the control signal thereto for controlling the computer power. The power control line can be coupled with the power switch pins or reset switch pins of the system panel connector. The control signal can be generated by a processor of the KVM switch according to a command of the console user. In another way, the control signal is generated by pushing a power switch button or a reset switch button of the KVM switch by the console user.

The power control method of the present invention includes the follow steps:

generating at least one control signal at the KVM switch;

transmitting the control signal through at least one power control line to a system panel connector of a mainboard of the computer; and

controlling computer power of the computer according to the control signal transmitted to the system panel connector of the mainboard.

Accordingly, the present invention allows the console user of the KVM switch to control computer power directly in an easy and cheap way than well known prior arts.

### BRIEF DESCRIPTION OF THE DRAWINGS

FIG. 1 depicts a diagram of a KVM management system capable of controlling computer power through at least one power control line coupled with the system panel connector of the mainboard of a computer.

FIG. 2 illustrates an embodiment of a 3-in-1 cable for connecting a KVM switch and a power control line according to the present invention.

FIG. 3 illustrates another embodiment of a dongle cable for connecting a KVM switch and a power control line according to the present invention.

FIG. 4 illustrates an embodiment of a KVM extender employing the present invention capable of controlling computer power by setting a power switch button and a reset switch button at the local module, the remote module or the consoles.

FIG. 5 illustrates an embodiment of a matrix KVM employing the present invention capable of controlling computer power by setting a power switch button and a reset switch button at the console or the dongle nearby.

FIG. 6 depicts a flow chart of a power control method according to the present invention.

### DETAILED DESCRIPTION OF THE INVENTION

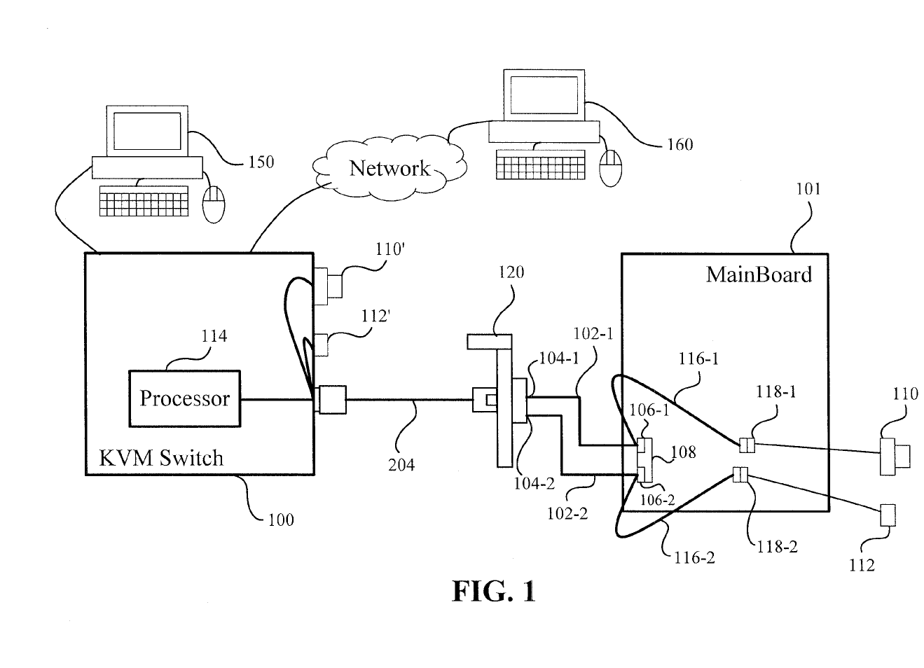

Please refer to FIG. 1, which depicts a diagram of a KVM management system capable of controlling computer power through a power control line 102-1 or 102-2 coupled with a computer (not shown). In one embodiment, the power control line 102-1 or 102-2 is coupled with a system panel connector 108 of a mainboard 101 (such as motherboard) of the computer. The whole remote control system in this embodiment includes a KVM switch 100, a plurality of computers coupled therewith (one is the computer having the mainboard 101), at least one console 150 or 160 according to the type of the KVM switch 100 and the setup condition of the whole remote control system. The console 150 can be a set of keyboard, mouse and monitor connected with the KVM switch 100 directly. The console 160 can be a computer system coupled with the KVM switch 100 through a network. In one embodiment, the network includes Internet, Intranet, Ethernet, Local area network (LAN), Wide area network (WAN) or wireless network.

The KVM management system of the present invention includes the KVM switch 100 and at least one power control line 102-1 or 102-2. The KVM switch 100 generates at least one control signal according to commands from a console user of the console 150 or 160 and then sends through a cable 204 (described in greater detail later) and the power control line 102-1 or 102-2 to the mainboard 101 of the computer. The power control line 102-1 includes a first end 104-1 to receive the control signal from the KVM switch 100. The power control line 102-2 includes a first end 104-2 to receive the control signal from the KVM switch 100. The power control line 102-1 further includes a second end 106-1 coupled with a system panel connector 108 of the mainboard 101. The power control line 102-2 further includes a second end 106-2 coupled with a system panel connector 108 of the mainboard 101. The power control line 102-1 or 102-2 transmits the control signal to the mainboard 101 for controlling the computer power of the computer.

As shown in FIG. 1, the power control line 102-1 is coupled with power switch pins (not shown) of the system panel connector 108; the power control line 102-2 is coupled with reset switch pins of the system panel connector 108. As well known, the power switch pins and the reset switch pins are correspondingly connected with a power switch button 110 and a reset switch button 112, which are usually set at the front panel of the computer. In this embodiment of the present invention, for coupling the second end 106-1 of the power line 102-1 or the second end 106-2 of the power line 102-2 to the system panel connector 108 of the mainboard 101, an original end 118-1 of the power switch button 110 and an original end 118-2 of the reset switch button 112 have to removed but for keeping them normally functional, two parallel wires 116-1 and 116-2 can be illustrated to connect with the original end 118-1 of the power switch button 110 and the original end 118-2 of the reset switch button 112 by male-female connecting means. Other designs capable of realizing the same accomplishment also can be considered.

As aforementioned, the control signal can be generated by a processor 114 of the KVM switch 100 according to commands from the console 150 or 160. For example, the control signal can be outputted from control pins (such as GPIO pins) of the processor 114. Alternatively, buttons 110′ and 112′ alike the power switch button 110 and the reset switch button 112 of the computer can be located at the KVM switch 100 as shown in FIG. 1. In general cases of setting up the whole remote control system, the KVM switch 100 can be close to the console user, and then the console user also can push the buttons 110′ or 112′ just like pushing the power switch button 110 and the reset switch button 112 of the computer beside the computer. Moreover, in cases that KVM switch 100 is not close to the console 150 or 160, such as, a remoter including the alike buttons 110′ and 112′ which is extended from the KVM switch 100 with a cable or wireless communication link can also be illustrated and can be more convenient for the console user.

Furthermore, the power control line 102-1 or 102-2 can be coupled with a connecting port of an expansion slot bracket 120 for a better and friendly setup about the KVM management system and the power control line 102-1 or 102-2 of the present invention. In one embodiment, the KVM switch 100 is electrically connected to connector port of the expansion slot bracket 120 via the cable 204.

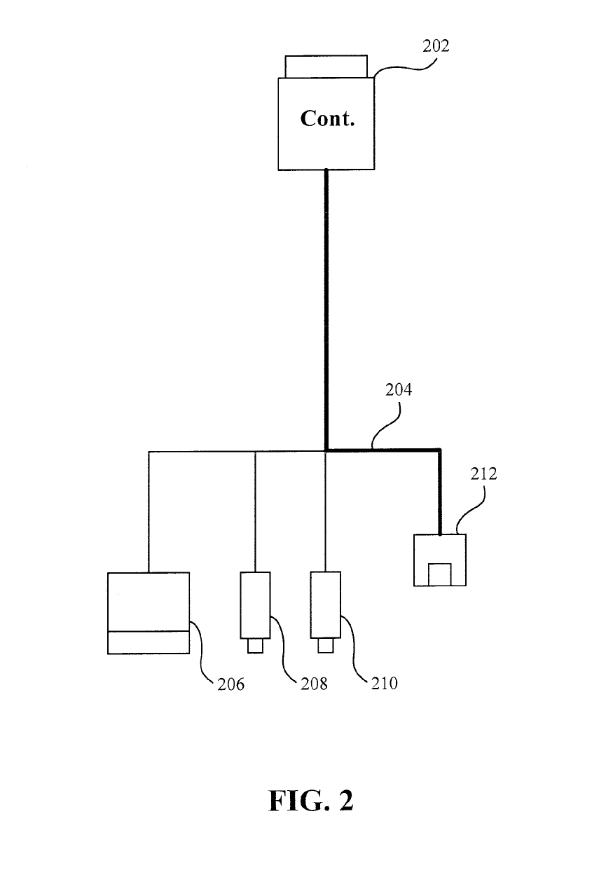

Please refer to FIG. 2, which illustrates an embodiment of a 3-in-1 cable (cable 204 shown in FIG. 1) for connecting a KVM switch 100 and the power control line 102-1 or 102-2 according to the present invention. Please also refer to FIG. 1. For transmitting the control signal from the KVM switch 100 to the mainboard 101, the cable 204 may need some special design. In this embodiment, the 3-in-1 cable can include a particular connector 202 for electrically connecting to the KVM switch 100 and for receiving keyboard-video-mouse signals from the KVM switch 100. Moreover, the control signal for controlling computer power is also received therefrom. The 3-in-1 cable can include a video connector 206, a keyboard connector 208, a mouse connector 210 and a connector 212 for jointing the aforesaid connector port of the expansion slot bracket 120. In one embodiment, the video connector 206 may be a VGA connector. The keyboard connector 208 and the mouse connector 210 may be PS/2 connectors.

Either the control signal is generated by the processor 114 according to the commands from the console user or generated by the buttons 110′ and 112′, the computer power of the computer can be controlled directly and simply by the console user, even the operation system crash happened. Accordingly, the present invention is easy and simple for solving drawbacks of prior arts. Furthermore, the present invention can be employed for general KVMs, such as analog KVMs with the console 150 as aforementioned. Specifically, it is much cheaper, easier and more efficient than prior arts.

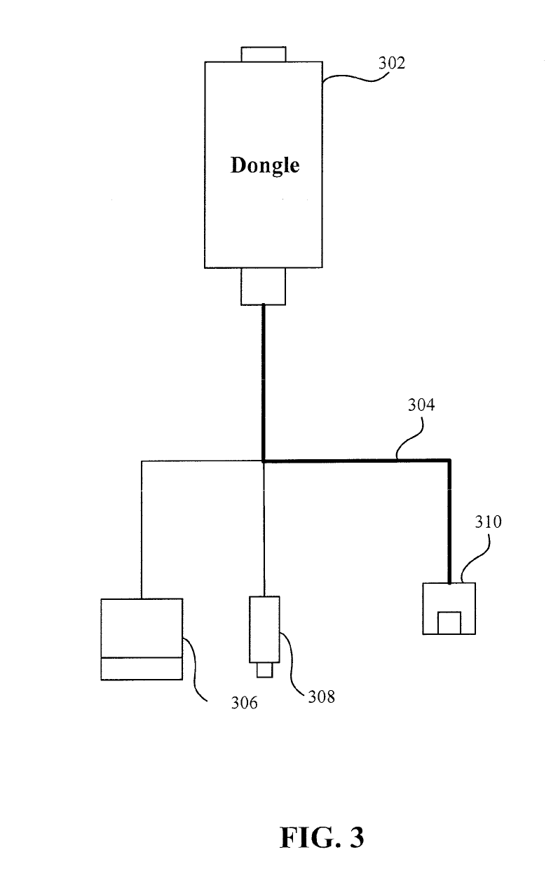

Please refer to FIG. 3, which illustrates another embodiment of a computer dongle cable 304 (cable 204 shown in FIG. 1) for connecting the KVM switch 100 and the power control line 102-1 or 102-2 according to the present invention. Please also refer to FIG. 1. In this embodiment, the type of the KVM switch 100 can be a Matrix KVM routing keyboard-video-mouse signals between the console and the computers by using a console dongle, a KVM host and the computer dongle. For example, the Matrix KVM transceives differential signals with RJ-45 Ethernet cable between the KVM host and the console dongle connected to console 150 in FIG. 1, and between the KVM host and the computer dongle connected to the computer with mainboard 101 in FIG. 1. In such circumstance, the computer dongle cable 304 or a computer dongle (conditioning circuit or KVM extender) with a corresponding cable can be illustrated for transmitting the control signal from the KVM switch 100 to the mainboard 101.

Similarly described as aforesaid cable 204, the computer dongle cable 304 may also need some special design. The computer dongle cable 304 can include a computer dongle for receiving keyboard-video-mouse data packets from the KVM switch 100. Moreover, the control signal, which has transformed into digital data packet at the KVM switch 100, is also received therefrom. The computer dongle cable 304 can include a video connector 306, a USB connector 308 for keyboard/mouse simulation and a connector 310 for jointing the aforesaid connector port of the expansion slot bracket 120 shown in FIG. 1.

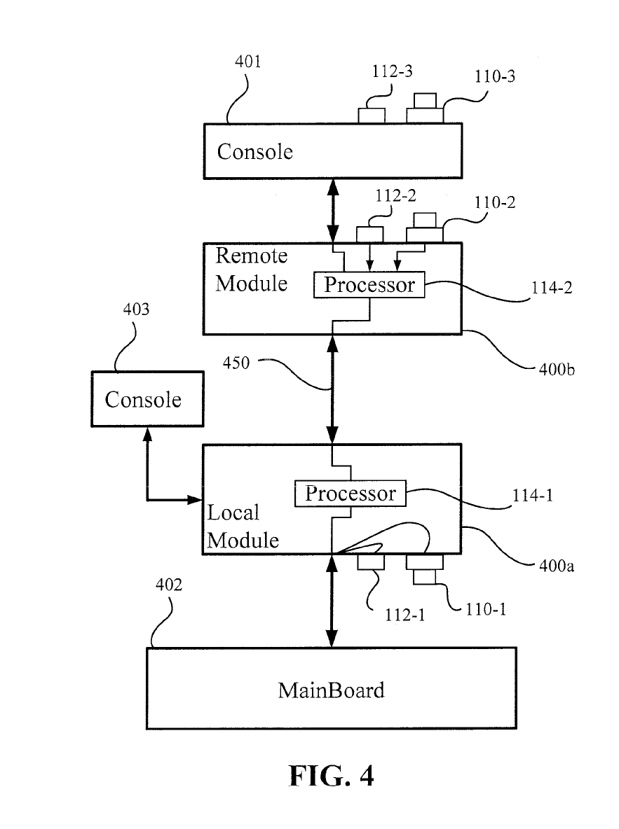

Please refer to FIG. 4, which illustrates an embodiment of a KVM extender employing the present invention capable of controlling computer power by setting a power switch button and a reset switch button at the local module 400a, the remote module 400b or the console 401 (remote client). In general, the KVM extender is employed to extend the communication distance between the computer (which comprises the mainboard 402) and the console 401. A console user can access the computer at the console 401, connecting with the remote module 400b or a console 403 (local console), connecting with the local module 400a. In one embodiment, the console 401 and 403 includes keyboard, mouse and monitor.

As aforementioned, the control signal can be generated by a processor 114-1 of the local module 400a according to commands from the user of the console 403 by hotkey or functional button. For example, the control signal can be outputted from control pins (such as GPIO pins) of the processor 114-1. Alternatively, buttons 110-1 and 112-1 alike the power switch button 110 and the reset switch button 112 of the computer (shown in FIG. 1) can be located at the local module 400a as shown in FIG. 4. In one embodiment, the buttons 110-1 and 112-1 maybe extend from the local module 400a via a cable or wireless communication link. When a user pushes the buttons 110-1 or 112-1 just like pushing the power switch button 110 or the reset switch button 112 of the computer beside the computer, the control signal is generated and sent to the processor 114-1. Then, the processor 114-1 deliveries the control signal to the mainboard 402 of the computer to control the computer power thereof. When a user pushes the hotkey or functional button in the console 403, the control signal is generated and sent to the processor 114-1. Then, the processor 114-1 deliveries the control signal to the mainboard 402 of the computer to control the computer power thereof.

Furthermore, the control signal also can be generated by a processor 114-2 of the remote module 400b according to commands from the user of the console 401 by hotkey or functional button. For example, the control signal can be outputted from control pins (such as GPIO pins) of the processor 114-2. Alternatively, buttons 110-2 and 112-2 alike the power switch button 110 and the reset switch button 112 of the computer (shown in FIG. 1) can be located at the remote module 400b as shown in FIG. 4. In one embodiment, the buttons 110-2 and 112-2 maybe extend from the remote module 400b via a cable or wireless communication link. When a user pushes the buttons 110-2 or 112-2 just like pushing the power switch button 110 or the reset switch button 112 of the computer beside the computer, the control signal is generated and sent to the processor 114-2. Then, the processor 114-2 deliveries the control signal to the mainboard 402 of the computer to control the computer power thereof.

Furthermore, buttons 110-3 and 112-3 alike the power switch button 110 and the reset switch button 112 of the computer (shown in FIG. 1) also can be located at the console 401 as shown in FIG. 4. A remoter including the alike buttons 110-3 and 112-3 which is extended from the remote module 400b with a cable or wireless communication link can also be illustrated and the remoter can be more convenient for the user of the console 401 because the remoter can be positioned nearby. Alternatively, the alike buttons 110-3 and 112-3 also can be the power switch button and the reset switch button of the console 401. With the same connection of the power control line 102-1 or 102-2 to the mainboard 101 of the computer as shown in FIG. 1, the user of the console 401 can push the power switch button or the reset switch button of the console 401 (the alike button 110-3 or 112-3), and then, the control signal is generated to the processor 114-2 of the remote module 400b. The remote module 400b sends the control signal for the mainboard 402. Consequently, the user of the console 401 can shutdown the console 401 and the computer by one single motion.

Specifically, a transmission cable 450 between the local module 400a and the remote module 400b is a CAT-5 cable in general. Therefore, the control signal generated at the remote module 400b or the console 401 has to be sent to the processor 114-2 first and has to be converted into data packets for transmission protocol between the local module 400a and the remote module 400b. Then, the control signal is reversely converted at the local module 400a and the processor 114-1 sends the control signal in the same way as described relative to FIG. 1 for controlling the computer power of the computer. When a user pushes the hotkey or functional button in the console 401, the control signal is generated and sent to the processor 114-1. Then, the control signal, via the remote module 400b, cable 450 and local module 400a, is transmitted to the mainboard 402 of the computer to control the computer power thereof.

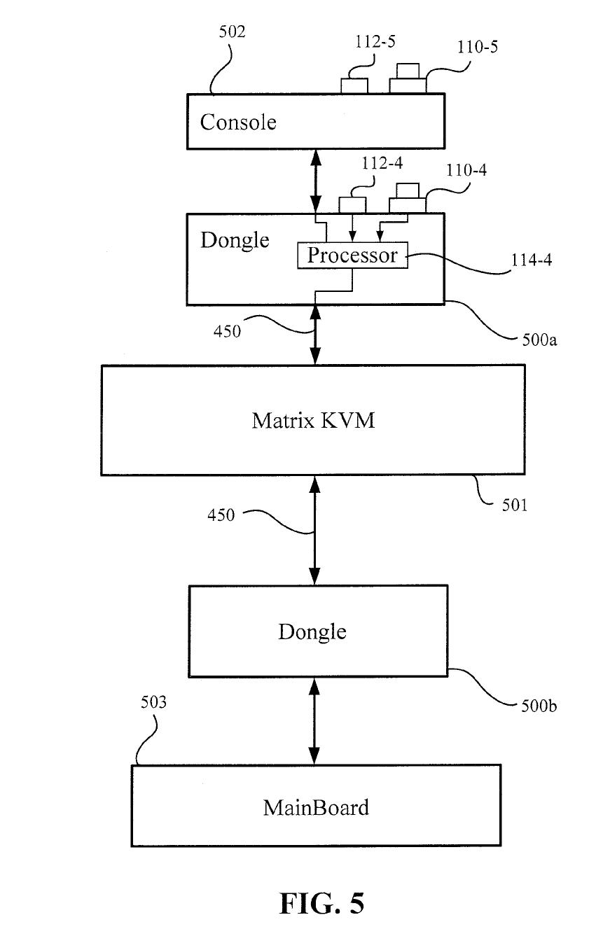

Please refer to FIG. 5, which illustrates an embodiment of a matrix KVM 501 employing the present invention capable of controlling computer power by setting a power switch button and a reset switch button at the console 502 (remote client) or a console dongle 500a nearby. In general, the matrix KVM 501 (such as KVM host) is employed for multiple users to respectively access a plurality of computers at the same time. The matrix KVM 501 is generally coupled with one console (such as the console 502 in FIG. 5) via the console dongle 500a and coupled with one of the computers (such as the mainboard 503 in FIG. 5) via a computer dongle 500a. A console user can access one (which comprises the mainboard 503) of the computers at the console 502.

As aforementioned, the control signal can be generated by a processor 114-4 of the console dongle 500a according to commands from the console 502 by hotkey or functional button. For example, the control signal can be outputted from control pins (such as GPIO pins) of the processor 114-4. Alternatively, buttons 110-4 and 112-4 alike the power switch button 110 and the reset switch button 112 of the computer (shown in FIG. 1) can be located at the console dongle 500a as shown in FIG. 5. When the user of the console 502 pushes the buttons 110-4 or 112-4 just like pushing the power switch button 110 or the reset switch button 112 of the computer beside the computer, the control signal is generated and sent to the processor 114-4. Then, the processor 114-4 deliveries the controls signal to the mainboard 503 of the computer to control the computer power thereof.

Furthermore, buttons 110-5 and 112-5 alike the power switch button 110 and the reset switch button 112 of the computer (shown in FIG. 1) also can be located at the console 502 as shown in FIG. 5. A remoter including the alike buttons 110-4 and 112-4 which is extended from the console dongle 500a with a cable or wireless communication link can also be illustrated and the remoter can be more convenient for the user of the console 502 because the remoter can be positioned nearby. Alternatively, the alike buttons 110-5 and 112-5 also can be the power switch button and the reset switch button of the console 502. With the same connection of the power control line 102-1 or 102-2 to the mainboard 101 of the computer as shown in FIG. 1, the user of the console 502 can push the power switch button or the reset switch button of the console 502 (the alike button 110-5 or 112-5), and then the control signal is generated to the processor 114-4 of the console dongle 500a. The console dongle 500a sends the control signal for the mainboard 503. Consequently, the user of the console 502 can shutdown the console 502 and the computer by one single motion. In one embodiment, the buttons 110-5 and 112-5 maybe extend from the console 502 via a cable or wireless communication link.

Specifically, transmission cables 450 for connecting the matrix KVM 501, the console dongle 500a and the computer dongle 500a are CAT-5 cables in general. Therefore, the control signal generated at the console dongle 500a or the console 502 has to be sent to the processor 114-4 first and converted into data packets for transmission protocol between the matrix KVM 501, the console dongle 500a and the computer dongle 500a. Then, the control signal is reversely converted at the computer dongle 500a and the processor of the computer dongle 500a sends the control signal in the same way as described relative to FIG. 1 for controlling the computer power of the computer. When a user pushes the hotkey or functional button in the console 502, the control signal is generated and sent to the processor 114-4. Then, the control signal, via the console dongle 500a, cable 450s, matrix KVM 501 and computer dongle 500b, is transmitted to the mainboard 503 of the computer to control the computer power thereof.

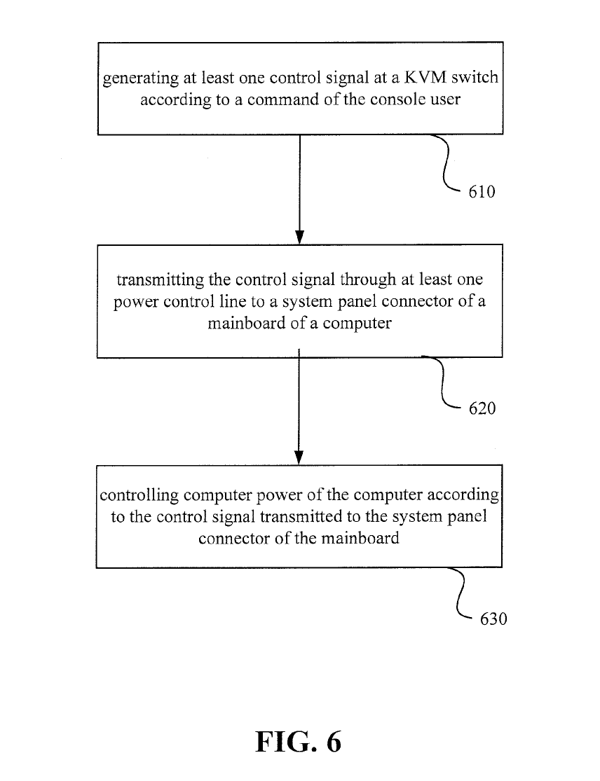

Please refer to FIG. 6, which depicts a flow chart of a power control method according to the present invention. The power control method of a KVM switch to a computer coupled therewith includes the follow steps:

Step 610, generating at least one control signal at the KVM switch according to a command of the console user (The console can generate and send commands to the processor of the KVM switch, and then the processor generates the control signal, accordingly. Alternatively, the console user can push the alike buttons of the power switch button or the reset switch button at the KVM switch to generate the control signal directly);

Step 620, transmitting the control signal through at least one power control line to a system panel connector of a mainboard of the computer; and

Step 630, controlling computer power of the computer according to the control signal transmitted to the system panel connector of the mainboard.

In conclusion, the KVM management system and the power control line of the present invention are easy and simple but solve drawbacks similarly. By directly and simply sending the control signal to the system panel connector of the mainboard, an essential and desired solution, which is easier, simpler and more excellent than prior arts for consideration of practical operation is realized according to the present invention.

In one embodiment, the computer control button may be disposed on any kind of KVM management device including Cable KVM, KVMP, Matrix KVM, KVM over IP, KVM extender, KVM power over the net, KVM serial over the net, LCM KVM and so on.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A KVM management system, comprising:
a KVM management device, generating at least one control signal; and
at least one power control line, coupled between the KVM management device and a connector of a mainboard in a computer to transmit the control signal of the KVM management device to control the computer power.

2. The KVM management system according to claim 1, wherein the power control line is coupled with power switch pins of the connector.

3. The KVM management system according to claim 2, wherein the control signal is generated by a processor of the KVM management device.

4. The KVM management system according to claim 2, wherein the control signal is generated by a power switch button of the KVM management device.

5. The KVM management system according to claim 2, further comprising an expansion slot bracket having a connecting port for coupling the power control line.

6. The KVM management system according to claim 1, wherein the power control line is coupled with reset switch pins of the connector.

7. The KVM management system according to claim 6, wherein the control signal is generated by a processor of the KVM management device.

8. The KVM management system according to claim 6, wherein the control signal is generated by a reset switch button of the KVM management device.

9. The KVM management system according to claim 6, further comprising an expansion slot bracket having a connecting port for coupling the power control line.

10. A KVM management system, comprising:
a KVM management device;
a computer connected to the KVM management device; and
at lease one computer power control button disposed on the KVM management device for control the computer power.

11. The KVM management system according to claim 10, wherein the computer power control button is a power switch button or a reset switch button.

12. The KVM management system according to claim 10, wherein the KVM management device comprises:
a remote module on which the computer power control button disposed; and
a local module connected between the remote module and the computer.

13. The KVM management system according to claim 12, wherein the computer power control button is a power switch button or a reset switch button.

14. The KVM management system according to claim 10, wherein the KVM management device comprises:
a remote module; and
a local module on which the computer power control button is disposed, wherein the local module is connected between the remote extender and the computer.

15. The KVM management system according to claim 14, wherein the computer power control button is a power switch button or a reset switch button.

16. The KVM management system according to claim 10, wherein the KVM management device comprises:
a first dongle on which the computer power control button is disposed;
a second dongle connected to the computer; and
a matrix KVM connected between the first dongle and the second dongle.

17. The KVM management system according to claim 16, wherein the computer power control button is a power switch button or a reset switch button.

18. The KVM management system according to claim 10, wherein the KVM management device connects to a remote client via a network.

19. The KVM management system according to claim 10, wherein the KVM management device connects to a local console.

20. The KVM management system according to claim 10, wherein the computer power control button extends from the KVM management device via a cable or a wireless communication link.
